(19) United States
(12) Patent Application Publication
(10) Pub. No.: US 2007/0269157 A1
(43) Pub. Date: Nov. 22, 2007

(54) Bearing Assemblies for the Pinion Shaft of an Axle Differential

(76) Inventors: Glenn R. Fahrni, Dalton, OH (US); Christopher S. Marks, North Canton, OH (US); Gregory C. Piotrowski, North Canton, OH (US); Michael F. Marcelli, White Lake, MI (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 11/659,889

(22) PCT Filed: Aug. 10, 2005
(86) PCT No.: PCT/US05/28388

§ 371 Date: Feb. 9, 2007

Related U.S. Application Data
(60) Provisional application No. 60/600,534, filed on Aug. 11, 2004.

(51) Int. Cl. F16C 19/22; F16C 35/067

(52) U.S. Cl. 384/569; 29/700

(57) ABSTRACT

The vehicle differential includes a housing (40) having at least one bearing seat (41) that is aligned along an axis. The housing also includes a counter bore having an internal thread. A bearing assembly (20) located in at least one bearing seat (41) supports a pinion shaft. The bearing assembly (20) comprises a bearing (38) and a lock member (62). The bearing (38) is located in at least one bearing seat (41) and around the pinion shaft. The bearing (38) includes an outer race (45), an inner race (46) and rolling elements (47). The outer race has a raceway (48) that is inclined with respect to the axis. The outer race (45) also has an external thread (49) on the narrow/thin section of the outer race, that is located around the outer race (45) and that is engaged with the internal thread (43) of the housing counter bore to set the bearing (38) along the axis. The external thread (49) may have at least one of an axial groove (60) and a radial slot (56) such that the axial groove (60) is positioned within the external thread (49) and the radial slot (56) is positioned within the external thread (49) and the outer race (45). Additionally, the outer race may contain no axial grooves nor radial slots. The lock member (62) may removably attach to at least one of the axial groove (60) and the radial slot (56) of the outer race (45) and removably attaches to the housing (40) whereby the lock member (62) prevents rotation of the outer race (45) within the bearing seat (41) of the housing (40). The lock member may also attach to the outer race by other methods.

### CROSS REFERENCE TO RELATED APPLICATIONS

This application derives and claims priority from U.S. provisional application 60/600,534, filed 11 Aug. 2004.

### TECHNICAL FIELD

The present invention relates to an apparatus and process for adjusting a bearing assembly to a desired setting within a housing. In particular, the present invention relates to securing the bearing to the housing at the desired setting.

### BACKGROUND ART

In conventional automotive differentials, the drive pinion, which engages and drives the ring gear in the differential, mounts on and forms part of a pinion shaft. An opposite end of the pinion shaft couples with an engine of a vehicle through a transmission of the vehicle. Typically, the pinion shaft rotates in a housing of the differential on two single row tapered roller bearings—a head bearing and a tail bearing—mounted in an indirect configuration, that is to say, with small ends of the tapered rollers of the head bearing presented toward the small ends of the rollers for the tail bearing. Furthermore, some configurations include a gear located between the two tapered roller bearings.

Preferably, the bearings are set to a condition of preload, which is achieved by controlling the spacing between the inner races or cones of the two bearings. One way to obtain the correct preload setting is to install a spacer of the proper size between the two cones. Like the cones, the spacer fits over the pinion shaft. But this spacer installation requires maintaining an inventory of spacers of varying lengths. Moreover, the cones are tightly fitted to the shaft, which renders axial displacement and adjustment difficult.

### DISCLOSURE OF THE INVENTION

The invention relates to a bearing assembly positioned in a vehicle differential. The vehicle differential includes a housing having at least one bearing seat that is aligned along an axis. The housing also includes a counter bore having an internal thread. The bearing assembly is located in at least one bearing seat and supports a pinion shaft. The bearing assembly comprises a bearing and a lock member. The bearing is located around the pinion shaft. The bearing includes an outer race, an inner race and rolling elements.

The outer race has a raceway that is inclined with respect to the axis. The outer race also has an external thread on the narrow/thin section end of the outer race, that is located around the outer race and that is engaged with the internal thread of the housing counter bore to set the bearing along the axis. The external thread has at least one of an axial groove and a radial slot such that the axial groove is positioned within the external thread, and the radial slot is positioned within the external thread and the outer race.

The lock member removably attaches to at least one of the axial groove(s) and the radial slot(s) of the outer race and removably attaches to the housing, whereby the lock member prevents rotation of the outer race within the bearing seat of the housing.

The inner race has a raceway located around the shaft, the raceway being inclined with respect to the axis in the same direction as the outer raceway for the race. The rolling elements are located between and contacting the raceways.

### BRIEF DESCRIPTION OF DRAWINGS

FIG. 1 is a longitudinal sectional view of a front pinion shaft of a tandem axle of a vehicle differential showing a bearing assembly of the prior art, including a cone spacer and a gear between the two bearings;

FIG. 2A is a fragmentary sectional view of a bearing assembly constructed in accordance with and embodying the present invention;

FIG. 2B is a fragmentary sectional view of an outer race constructed in accordance with and embodying the present invention;

FIG. 2C is a fragmentary sectional view of another outer race constructed in accordance with and embodying the present invention;

FIG. 2D is a fragmentary sectional view of another outer race constructed in accordance with and embodying the present invention;

FIG. 3A is a perspective view of a lock member constructed in accordance with and embodying the present invention;

FIG. 3B is a fragmentary sectional view of the lock member of FIG. 3A connected with a portion of a differential housing and a portion of an outer race of the present invention;

FIG. 4A is a perspective view of another lock member constructed in accordance with and embodying the present invention;

FIG. 4B is a fragmentary sectional view of the lock member of FIG. 4A connected with a portion of a differential housing and a portion of an outer race of the present invention;

FIG. 5A is a perspective view of another lock member constructed in accordance with and embodying the present invention;

FIG. 5B is a fragmentary sectional view of the lock member of FIG. 5A connected with a portion of a differential housing and a portion of an outer race of the present invention;

FIG. 6A is a perspective view of another lock member constructed in accordance with and embodying the present invention;

FIG. 6B is a fragmentary sectional view of the lock member of FIG. 6A connected with a portion of a differential housing and a portion of an outer race of the present invention;

FIG. 7A is a perspective view of another lock member constructed in accordance with and embodying the present invention;

FIG. 7B is a fragmentary sectional view of the lock member of FIG. 7A connected with a portion of a differential housing and a portion of an outer race of the present invention;

FIG. 8 is a fragmentary view of another lock member connected with a portion of a differential housing and a portion of an outer race of the present invention;

FIG. 9A is a fragmentary sectional view of another lock member connected with a portion of a differential housing and a portion of an outer race constructed in accordance with and embodying the present invention;

FIG. 9B is a fragmentary sectional view of another outer race constructed in accordance with and embodying the present disclosure;

FIG. 9C is a fragmentary sectional view of another lock member connected with a portion of a differential housing and a portion of an outer race constructed in accordance with and embodying the present invention;

FIG. 10A a front perspective view of a setting tool constructed in accordance with and embodying the present invention;

FIG. 10B is a back perspective view of the setting tool of FIG. 10A;

FIG. 10C is a fragmentary sectional view of a lock member fastened to an outer race constructed in accordance with and embodying the present invention;

FIG. 10D is a cross section view taken along line “10D-10D” of FIG. 10C;

FIG. 10E is a fragmentary sectional view of the lock member of FIGS. 10C and 10D;

FIG. 10F is a cross sectional view taken along line “10F-10F” of FIG. 10E;

FIG. 11A is a front perspective view of a setting tool constructed in accordance with and embodying the present invention;

FIG. 11B is a back perspective view of the setting tool of FIG. 11A;

FIG. 11C is a fragmentary sectional view of a lock member fastened to an outer race constructed in accordance with and embodying the present invention;

FIG. 11D is a cross section view taken along line “11D-11D” of FIG. 11C;

FIG. 11E is a fragmentary sectional view of the lock member of FIGS. 11B and 11C;

FIG. 11F is a cross sectional view taken along line “11F-11F” of FIG. 11E;

FIG. 12A is a back perspective view of a setting tool constructed in accordance with and embodying the present invention;

FIG. 12B is a fragmentary sectional view of a lock member fastened to an outer race constructed in accordance with and embodying the present invention;

FIG. 12C is a cross section view taken along line “12C-12C” of FIG. 12B;

FIG. 12D is a fragmentary sectional view of the lock member of FIGS. 12B and 12C;

FIG. 12E is a cross sectional view taken along line “12E-12E” of FIG. 12D.

### BEST MODE FOR CARRYING OUT THE INVENTION

The present invention relates to adjusting a bearing assembly in a housing whereby the outer race of the bearing is an adjustable member. The invention may be used for a variety of bearing assemblies in indirect bearing mountings, which are positioned within a variety of applications. Typically, indirect mountings are cone-adjusted. In rotating shaft applications requiring tight-fitted cones, adjusting through the cones is difficult. For illustrative purposes, the following description shows tapered roller bearing assemblies positioned within a housing for automotive differentials.

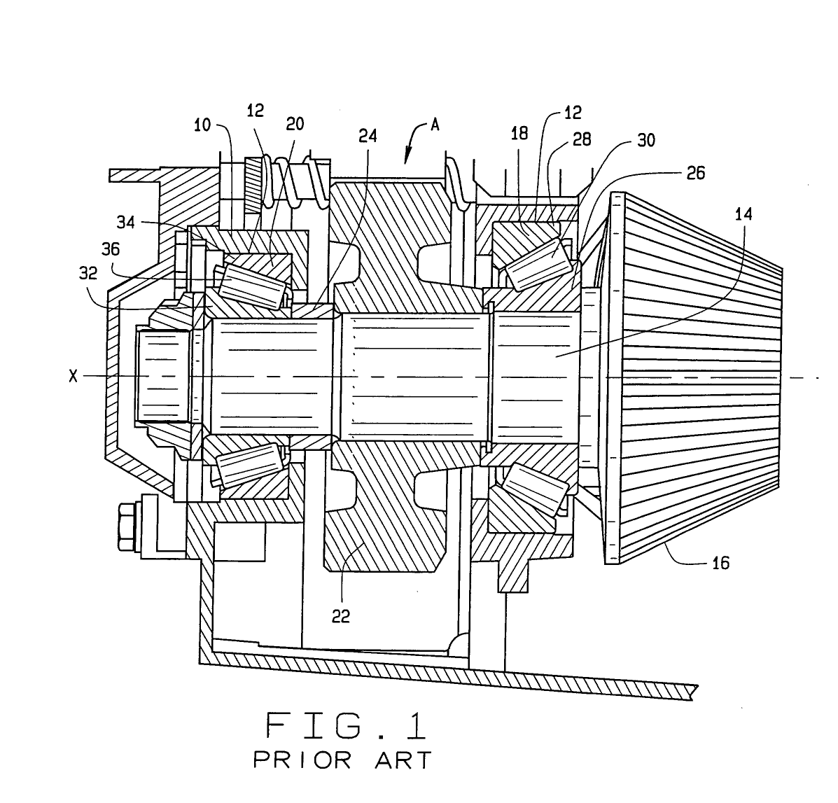

Referring to the drawings, a conventional pinion shaft of a vehicle differential A (FIG. 1) for a front drive axle of a vehicle having dual drive axles is shown. The differential A includes a housing 10, having bearing seats 12, a pinion shaft 14, a pinion 16, bearings 18, 20, helical gear 22 and spacer 24.

The pinion shaft 14 rotates within the housing 10 along an axis “X”. The pinion 16, which lies at the end of the pinion shaft 14, also rotates along the axis “X”. The pinion shaft 14 rotates in bearings 18, 20 mounted in bearing seats 12 of the housing 10. The bearings 18, 20, while permitting the pinion shaft 14 and its pinion 16 to rotate about the axis “X”, confine the pinion 16 radially and axially within the housing 10.

Bearing 18 (known as a head bearing) includes an inner race in the form of a cone 26 and includes an outer race in the form of a cup 28. Between the cone 26 and the cup 28 are rolling elements in the form of tapered rollers 30.

Bearing 20 (known as a tail bearing) includes an inner race in the form of a cone 32 and an outer race in the form of a cup 34. Between the cone 32 and the cup 34 are rolling elements in the form of rollers 36. The shaft 14 also carries the spacer 24 and the helical gear 22, which occupies the space between the cones 26, 32 of the two bearings 18 and 20. The helical gear 22 meshes with a gear that drives a shaft through which power is transferred to the second rear axle. The spacer 24, which is selected from an inventory of different sized spacers, determines the spacing between the two cones 26 and 32 and thus the setting for the two bearings 18, 20. Preferably, that setting is a slight preload, which eliminates all internal clearances in the bearings 18 and 20. The present invention uses one fixed length cone spacer, or an extended fixed length gear, or one extended cone length, or a combination of extended gear and extended cone, all of which replace the spacer selected from an inventory of spacers differing incrementally in length. Therefore, reduced number of parts is needed in the present invention. Currently, several teardowns and rebuilds may be required to obtain the correct spacer width to properly adjust the bearings. The present invention results in no rebuilds, more accurate and easier verification of bearing settings, and thus reduced assembly time. The present invention also simplifies service replacement.

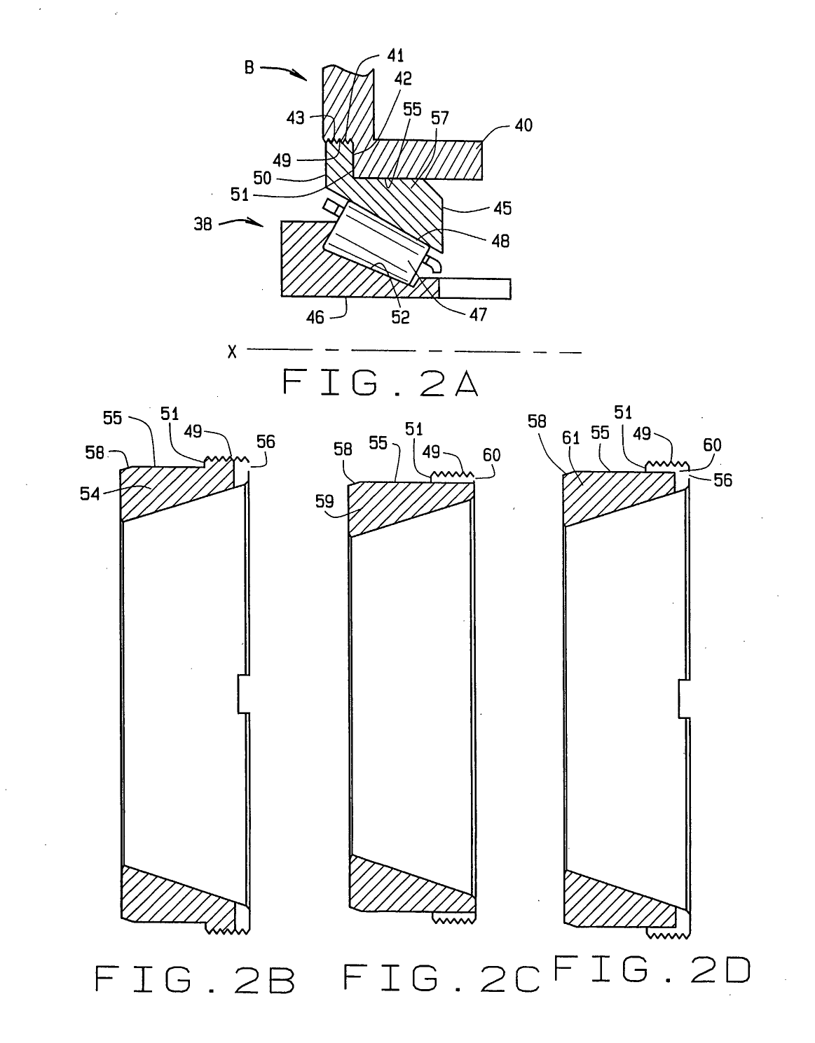

Referring to FIG. 2A, portions of another vehicle differential B and portions of the tail bearing assembly 38 of the present invention are shown. The vehicle differential B includes a housing 40 that has at least one bearing seat inner diameter 57. The bearing seat inner diameter 57 aligns along axis “X”. The housing 40 also includes a housing shoulder 42. The housing 40 also includes a counter bore 41, which includes an internal thread 43.

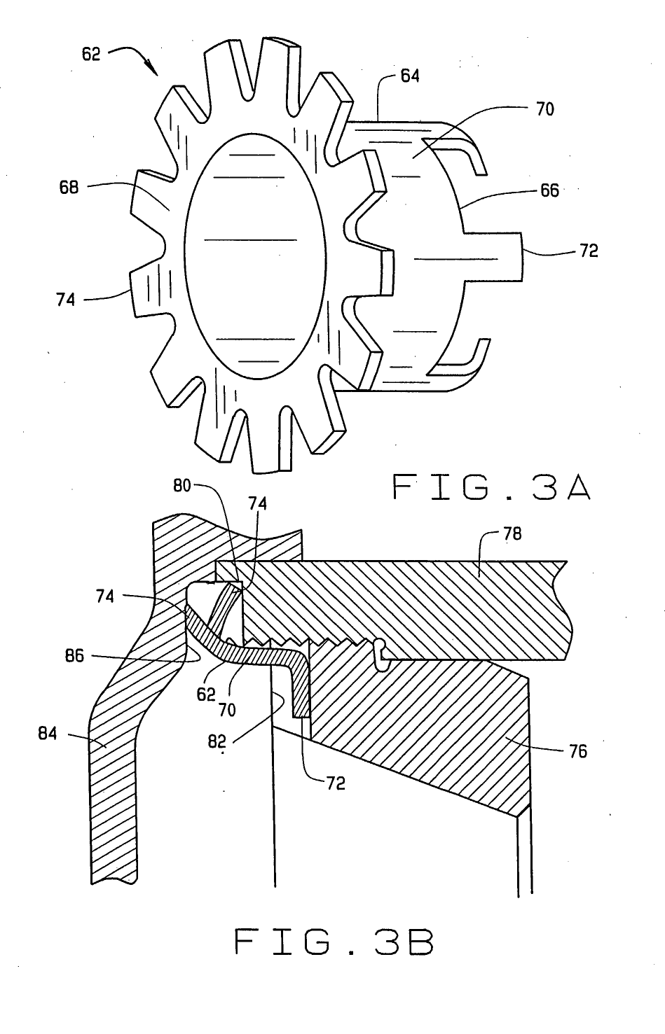

The bearing assembly 38 includes a cone 46 located around a conventional pinion shaft such as a shaft 14 shown in FIG. 1. The bearing assembly 38 also includes a lock member (FIGS. 3A-12F).

The bearing 38 includes an outer race 45, an inner race 46, and rolling elements 47. The outer race 45 has a raceway 48 that is inclined with respect to the axis. The outer race 45 also has an external thread 49 on the narrow/thin section end of the outer race 45 that is located around the outer race 45. The external thread 49 engages with internal thread 43 of the housing counter bore 41 to set the bearing 38 along the axis. The outer race 45 further includes a flange portion 50 having a face 51.

The inner race 46 has a raceway 52 located around a conventional pinion shaft such as shaft 14 (FIG. 1). The raceway 52 is inclined with respect to the axis in the same direction of the raceway 48 of the outer race 45. The rolling elements 47 are located between the contacting raceways 48 and 52.

The outer race 45 rotates within the housing 40 until the face 51 of the flange portion 50 bottoms against the housing shoulder 42, and wherein this abutment provides a reference position. The outer race 45 further counter-rotates away from housing shoulder 42 until the bearing 38 has a desired setting. The desired setting should be one of preload and may be characterized by a predetermined torque, a predetermined advancement angle, or a predetermined portion of a turn of the outer race 45 within the housing 40 or any other predetermined method. FIGS. 2B-2D illustrate different embodiments for an outer race which may be assembled with the bearing cone 46 and rolling elements 47 (FIG. 2A). As such, common race elements retain common element numbers.

A threaded outer race 54 (FIG. 2B) constructed in accordance with and embodying the present invention may be assembled in bearing assembly 38 (FIG. 2A). Outer race 54 provides radial slots 56 positioned within the external thread 49 and within a portion of the outer race 54 to engage a lock member (not shown) as will be discussed. These radial slots 56 enable the outer race 54 to be engaged with a setting tool and turned to be secured in the desired setting. Additionally, the use of a lead-in chamfer 58 allows ease of insertion of the outer race 54 into housing 40 so that the external thread 49 will align properly with the housing internal thread 43 (FIG. 2A). In addition, the fits between the external thread 49 and internal thread 43 are more loose than the fit between an outer cylindrical surface 55 of the outer race 54 and the bearing seat inner diameter 57 (FIG. 2A) of the housing 40, to assure radial and tilting bearing loads pass into the housing 40 through the contact area between the outer cylindrical surface 55 of the outer race 54 and the bearing seat inner diameter 57 of the housing 40, and the threads take pure pinion thrust load only. The flange face 51 will allow the outer race 54 to bottom against the housing shoulder 42 (FIG. 2A) in which the tolerance stackup of the components will assure a reference end play setting.

Knowing the difference between the reference end play and desired preload settings, the outer race 54 is then counter-rotated through an angle that retracts it enough to provide the proper preload setting. Alternatively, the outer race 54 could be retracted while monitoring bearing rolling torque, that is to say by monitoring resistance to rotation imposed by bearing 38. When the desired rolling torque is obtained, retractment is terminated, thereby providing the proper preload setting. All tolerance stackups and end play loss due to clamp loading and tight fits are accounted for using this adjustment method. The lock member (FIGS. 3A-12F) may then secure the outer race 54 against rotation in the housing 40, as will be discussed.

Another outer race 59 (FIG. 2C) constructed in accordance with and embodying the present invention may be assembled in bearing assembly 38 (FIG. 2A). Outer race 59 provides axial grooves 60 in the external thread 49 for a lock member (not shown) as will be discussed. Additionally, the use of the lead-in chamfer 58 allows ease of insertion of the outer race 59 into the housing 40 so that the external thread 49 will align properly with the housing internal thread 43 (FIG. 2A). In addition, the fits between the external thread 49 and internal thread 43 will always be more loose than the fit between the outer cylindrical surface 55 of the outer race 59 and the bearing seat inner diameter 57 (FIG. 2A) of the housing 40, to assure radial and tilting bearing loads pass into the housing 40 through the contact area between the outer cylindrical surface of the outer race 59 and the bearing seat inner diameter 57 of the housing 40, and the threads take pure pinion thrust load only. The flange face 51 will allow the outer race 59 to bottom against housing shoulder 42 (FIG. 2A) in which the tolerance stackup of the components will assure a reference end play setting.

Knowing the difference between the reference end play and desired preload settings, the outer race 59 is counter-rotated through an angle that retracts it enough to provide the proper preload setting. Alternatively, the outer race 59 could be retracted while monitoring bearing rolling torque, that is to say by monitoring resistance to rotation imposed by bearing 38. When the desired rolling torque is obtained, retractment is terminated, thereby providing the proper preload setting. All tolerance stackups and end play loss due to clamp loading and tight fits are accounted for using this adjustment method. The lock member (FIGS. 3A-12F) may then secure the outer race 59 against rotation in the housing, as will be discussed.

Another outer race 61 (FIG. 2D) constructed in accordance with and embodying the present invention may be assembled in bearing assembly 38 (FIG. 2A). Outer race 61 provides both a radial slot 56 and an axial groove 60 positioned within the external thread 49 for a lock member (not shown) to engage and allow for advancement or retraction of the outer race 61 to its proper bearing setting position. In this embodiment, the axial groove 60 is positioned perpendicular to the radial slot 56. Additionally, the use of lead-in chamfer 58 allows ease of insertion of the outer race 61 into the housing 40, so that the external thread 49 will align properly with the housing internal thread 43 (FIG. 2A). In addition, the fits between the external thread 49 and housing internal thread 43 are more loose than the fit between the outer cylindrical surface 55 of the outer race and the bearing seat inner diameter 57 (FIG. 2A) of the housing 40, to assure radial and tilting bearing loads pass into the housing 40 through the contact area between the outer cylindrical surface 55 of the outer race 61 and the bearing seat inner diameter 57 of the housing 40, and the threads take pure pinion thrust load only. The flange face 51 will allow the outer race 61 to bottom against housing shoulder 42 (FIG. 2A) in which the tolerance stackup of the components will assure a reference end play setting.

Knowing the difference between the reference end play and desired preload settings, the outer race 61 is then counter-rotated through an angle that retracts it enough to provide the proper preload setting. Alternatively, the outer race 61 could be retracted while monitoring bearing rolling torque, that is to say by monitoring resistance to rotation imposed by bearing 38. When the desired rolling torque is obtained, retractment is terminated, thereby providing the proper preload setting. All tolerance stackups and end play loss due to clamp loading and tight fits are accounted for using this adjustment method. The lock member (FIGS. 3A-12F) may secure the outer race against rotation in the housing as will be discussed.

As previously stated, a lock member secures the outer race (FIGS. 2B-2D) against rotation in the housing 40 (FIG. 2A). FIGS. 3A through 12F show lock members that prevent the outer race from turning in the housing 40 during shaft rotation, after the outer race and lock member have been installed and adjusted.

The present invention provides a lock member 62 (FIG. 3A) that comprises a body 64. The body 64 includes a first end 66, a second end 68 and a middle portion 70 disposed between the first end 66 and the second end 68. The first end 66 includes at least one extension 72. In this embodiment, each extension 72 co-planarly extends from the first end 66. The end of each extension 72 may angle inward with respect to the middle portion 70. The second end 68 includes at least one bendable ear 74. In this embodiment, each bendable ear 74 extends outward from the second end 68.

During operation, the desired setting (FIG. 3B) is obtained by engaging an outer race 76 with a setting tool and applying a torque to the setting tool either to a predetermined torque or predetermined angle or predetermined portion of a turn. Next, the lock member 62 removably connects to outer race 76 and to housing 78 to secure the outer race 76 against rotation in the housing 78. In this embodiment, the housing includes at least one slot 80 within the housing 78. The outer race 76 includes at least one radial slot 82. During operation, the user inserts the lock member 62 such that at least one extension 72 engages at least one radial slot 82 of the outer race 76. The user may then bend one of the bendable ears 74 to engage at least one slot 80 of the housing 78. This position may clamp the other bendable ears 74 against an inside face 86 of cover plate 84.

Thus, the lock member 62 of FIGS. 3A and 3B may comprise a stamping with internal extensions 72 that engage in radial slots 82 in the outer race front face, and with bendable ears 74 on its OD that are bent into at least one radial slot 80 provided in the housing 78. Remaining ears 74 not bent into the housing slots 80, because they do not align with the housing slot(s) 80, may be clamped against the inside face 86 of the cover plate 84. This spring loads, or clamps, the lock member 62 against the outer race 76, axially. The interlocking of extensions 72 and ears 74 with the radial slots 82 and housing grooves 80 respectively prevents the outer race 76 from turning within the housing 78 during operation. The number of bendable ears 74, and number of housing slot 80 can be selected/designed to provide the proper bearing setting range.

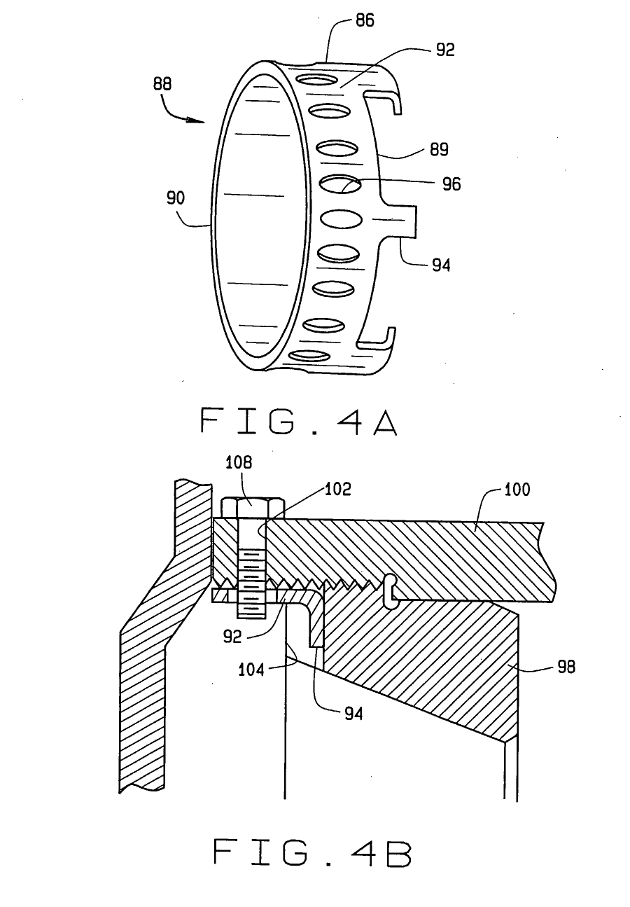

The present invention provides a lock member 88 (FIG. 4A) that comprises of body 86. The body includes a first end 89, a second end 90 and a middle portion 92 disposed between the first end 89 and the second end 90. The first end 89 includes at least one extension 94. In this embodiment, each extension 94 co-planarly extends from the first end 89. The end of each extension 94 may angle inward with respect to the middle portion 92. The middle portion 92 comprises a tube defining a plurality of holes 96 therethrough. In this embodiment, the holes 96 comprise oblong configurations.

During operation, the desired setting (FIG. 4B) is obtained by engaging an outer race 98 with a setting tool and applying a torque to the setting tool either to a predetermined torque or predetermined angle or predetermined portion of a turn. Next, the lock member 88 removably connects to outer race 98 and to a housing 100. In this embodiment, the housing 100 may include at least one threaded hole 102 which may radially run within the housing 100. The outer race 98 includes at least one radial slot 104.

During operation, the user inserts the middle portion 92 within the radial slot 104 of the outer race 98 such that all extensions 94 engage into all radial slots 104 of the outer race 98. The user may align one of the holes 96 with the threaded hole 102 of the housing 100. The user may then insert a fastener 108 such as a bolt through the threaded hole 102 of the housing 100 and through one of the plurality of holes 96 to fasten the lock member 88 to the housing 100 in order to fasten the outer race 98 to the housing 100. As such, the lock member 88 secures the outer race 98 against rotation in the housing 100 during operation.

Thus, the lock member 88 of FIGS. 4A and 4B may comprise a short, thin, stamped tube with extensions 94 that engage in radial slots 104 in the outer race front face, and may comprise a series of oblong-shaped holes 96 through the middle portion 92. One of the holes 96 in the middle portion 92 may engage with the fastener 108 inserted through the housing 100. The interlocking of the fastener 108 in the oblong hole 96, and the extensions 94 in the radial slots 104, prevents the outer race 98 from turning. The number of oblong holes 96 can be selected/designed to provide the proper bearing setting range, when the lock member 88 and outer race 98 are rotated slightly to align the fastener 108 with one of the holes 96.

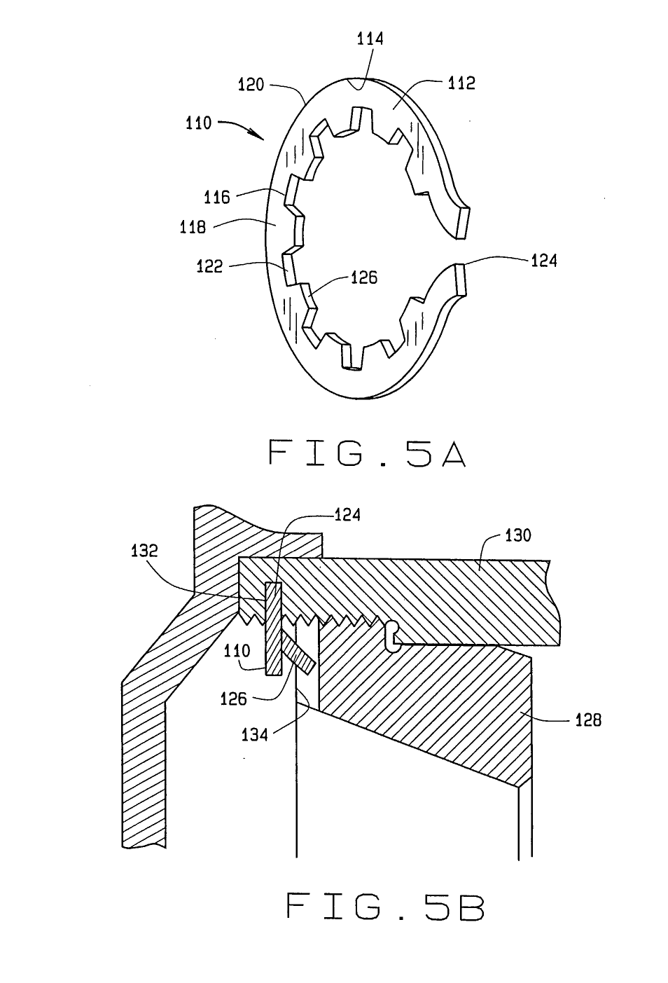

The present invention provides a lock member 110 (FIG. 5A) that comprises a body 112. The body 112 includes a first end 114 in the form of an outer edge, a second end 116 in the form of an inner edge and a middle portion 118 disposed between the first end 114 and the second end 116. In this embodiment, the body 112 may comprise a snap ring such that the first end 114 comprises an outer diameter 120 of the snap ring and the second end 116 comprises an inner diameter 122 of the snap ring. The first end 114 may include a pair of extensions 124 while the second end 116 may include at least one bendable ear 126. In this embodiment, each bendable ear 126 extends towards the center of the lock member 110.

During operation, the desired setting (FIG. 5B) is obtained by engaging an outer race 128 with a setting tool and applying a torque to the setting tool either to a predetermined torque or predetermined angle or predetermined portion of a turn. Next, the lock member 110 removably connects to outer race 128 and to a housing 130 to secure the outer race 128 against rotation within the housing 130. In this embodiment, the housing 130 includes a groove 132 which may radially run within the housing 130. The outer race 128 may include at least one radial slot 134 that may be positioned parallel with respect to the groove 132 of the housing 130. During operation, the user inserts the pair of extensions 124 into the groove 132 of the housing 130. The user may also bend one of the bendable ears 126 into at least one radial slot 134 to engage slot 134. As such, the lock member 110 secures the outer race 128 against rotation within the housing 130 during operation.

Thus, the lock member 110 of FIGS. 5A and 5B may comprise a snap ring with extensions 124 and bendable ears 126 that engage the groove 132 and the radial slots 134 respectively. The extensions 124 of the snap ring insert into the groove 132 of the housing 130, then the bendable ear 126 bends into the slot 134 in the front face of the outer race 128. The interlocking of the bendable ear 126 with the slot 134, and the extensions 124 with the groove 132 of the housing prevents the outer race 128 from turning during operation. The number of bendable ears 126 and number of slots 134 in the outer race front face are selected and designed to provide the proper bearing setting range.

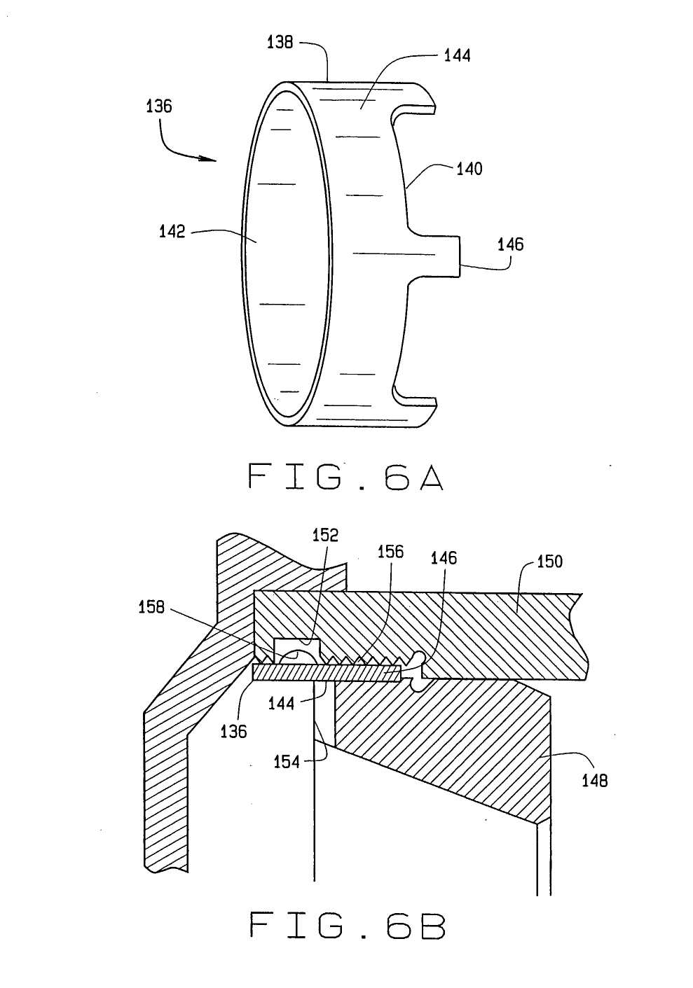

The present invention provides a lock member 136 (FIG. 6A) that includes a body 138. Body 138 includes a first end 140, a second end 142 and a middle portion 144 disposed between the first end 140 and the second end 142. The first end 140 includes at least one extension 146. In this embodiment, at least one extension 146 co-planarly extends from the first end 140.

During operation, the desired setting (FIG. 6B) is obtained by engaging radial slots 154 of the outer race 148 with a setting tool and applying a torque to the setting tool either to a predetermined torque or predetermined angle or predetermined portion of a turn. Next, the lock member 136 removably connects to outer race 148 and to a housing 150. In this embodiment, the housing 150 may include at least one hole 152 which may radiallly extend into the housing 150. The outer race 148 may include at least one radial slot 154 that may be positioned perpendicular with respect to the axial groove 156.

During operation, the user inserts the middle portion 144 and the extensions 146 within the axial groove(s) 156 of the outer race 148. The user may apply a tool (not shown) against the inner diameter of the middle portion 144 to form a dimple 158 extending away from the middle portion and towards the housing 150. The dimple 158 engages the hole 152 of the housing 150. As such, the lock member 136 secures the outer race 148 against rotation within the housing 150 during operation.

Thus, the lock member 136 of FIGS. 6A and 6B may comprise a thin hollow tube, with extensions 146 that engage in axial grooves 156 in the threaded OD of the outer race 148. A dimple 158 is then mechanically deformed into the hole 152 in the housing 150. The interlocking of the extensions 146 in the axial grooves 156 and the dimple 158 in the housing hole 152 prevents the outer race 148 from turning. An infinite bearing setting range is provided since the dimpling is done at the location of the housing hole 152, regardless of rotational position of the lock member 136 and the outer race 148.

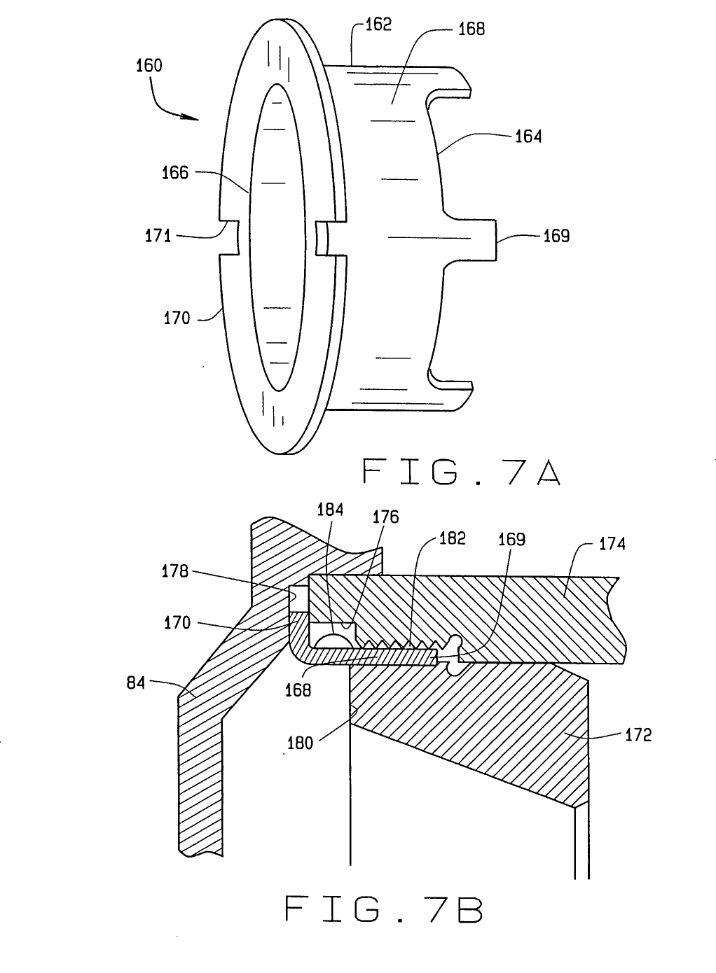

The present invention provides a lock member 160 (FIGS. 7A and 7B) that comprises a body 162. The body 162 includes a first end 164, second end 166, and a middle portion 168 disposed between the first end 164 and the second end 166. The first end 164 includes at least one extension 169. In this embodiment, at least one extension 169 co-planarly extends from the first end 164. The second end 166 includes a lip 170 that radially extends outward from the second end 166. The lip 170 may include notches 171, which mate with a setting tool (not shown) as will be discussed.

During operation, the desired setting (FIG. 7B) is obtained by engaging notches 171 with a setting tool and applying a torque to the setting tool either to a predetermined torque or predetermined angle or predetermined portion of a turn. Next, the lock member 160 removably connects outer race 172 with a housing 174. In this embodiment, the housing 174 may include at least one keyway 176 which may radially run within the housing 174. The cover plate 84 may also include at least one recess 178 that may circumferentially run within the cover plate 84. Furthermore the outer race 172 may include at least one axial groove 182.

During operation, the user may insert the middle portion 168 and the extensions 169 within the axial groove 182 of the outer race 172 until the lip 170 bottoms against the housing 174. The user may apply a tool (not shown) against the inner diameter of a portion of the middle portion 168 to form a dimple 184 extending away from the middle portion 168 and into the housing 174. The dimple 184 engages the keyway 176 of the housing 174. As such, the lock member 160 secures the outer race 172 against rotation within the housing 174 during operation.

The lock member 160 of FIGS. 7A and 7B may comprise a thin hollow tube with lip 170 on its second end 166, with extensions 169 that engage in axial grooves 182 in the threaded flange OD of the outer race 172. The dimple 184 is then mechanically deformed into the keyway 176. The interlocking of the extension 169 in the outer race grooves 182 and the dimple 184 in the housing keyway 176 prevents the outer race 172 from turning. An infinite bearing setting range is provided since the dimpling is done at the location of the housing keyway 176, regardless of rotational position of the lock member 160 and outer race 172.

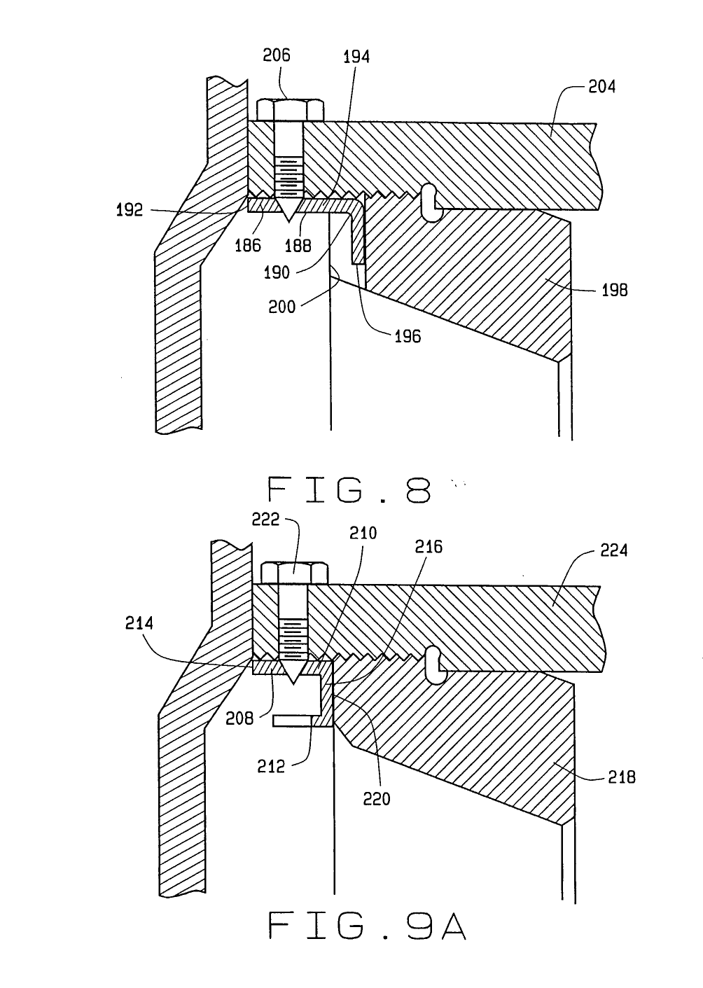

The present invention provides a lock member 186 (FIG. 8) that comprises a body 188. The body 188 includes a first end 190, a second end 192 and a middle portion 194 disposed between the first end 190 and the second end 192. The first end 190 includes at least one extension 196. In this embodiment, each extension 196 co-planarly extends away from the first end 190 wherein an end of each extension 196 angles inwardly from the first end 190. As shown, an outer race 198 includes at least one radial slot 200.

During operation, the desired setting is obtained by engaging outer race 198 with a setting tool and applying a torque to the setting tool either to a predetermined torque or predetermined angle or predetermined portion of a turn. Next, the lock member 186 removably connects to outer race 198 and to housing 204. To secure the outer race 198 against rotation within the housing 204, the user inserts the extensions 196 within the radial slots 200. The user may insert a fastener 206 through the housing 204 and through the body 188. The fastener 206 may comprise a cone point set screw. The fastener 206 may also comprise a needle point set screw. As such, the lock member 186 secures the outer race 198 against rotation in the housing 204 during operation.

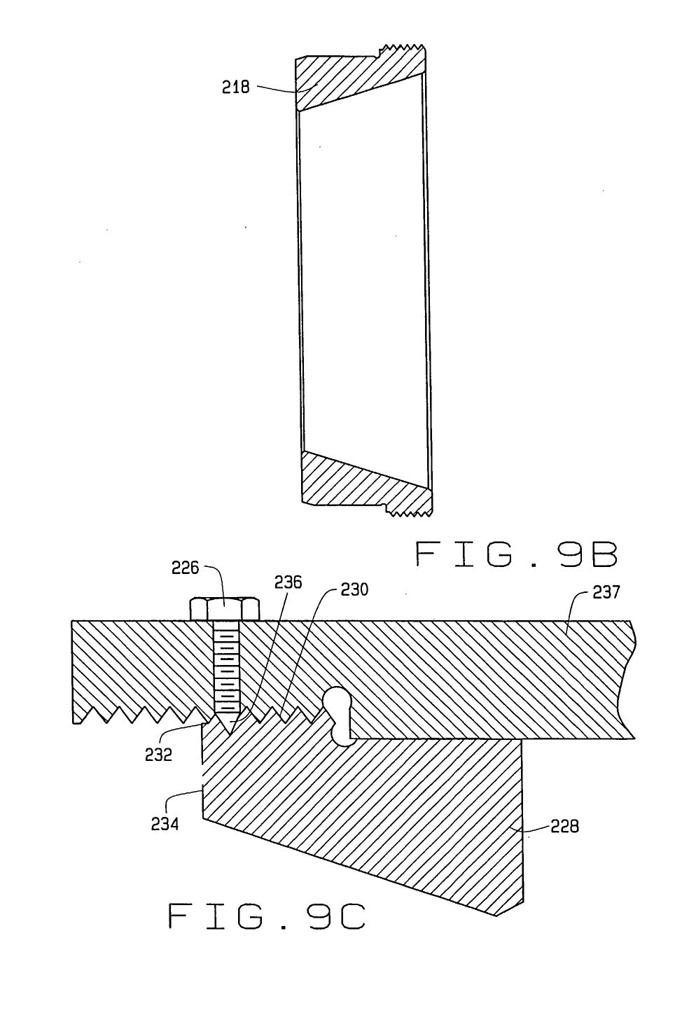

The present invention provides a lock member 208 (FIG. 9A) that comprises a body 210. The body 210 includes a first end 212 in the form of an inner lip, a second end 214 in the form of an outer lip, and a middle portion 216 disposed between the first end 212 and the second end 214. In this embodiment, the body 210 comprises a U-shaped configuration with the first, second ends 212, 214 opposing each other. The first end 212 may include an aperture defined therethrough to engage a setting tool (not shown). The user fastens the body 210 to an outer race 218 by a first fastener 220. In this embodiment, the first fastener 220 may comprise a weld such as a projection weld, laser weld or spot weld. The user may also insert a second fastener 222 through a housing 224 and then through the second end 214 of the body 210. In this embodiment, the second fastener 222 may include a cone point set screw or a needle point set screw.

FIGS. 8 and 9A show additional locking members that afford accurate bearing adjustment with the feature of infinite rotational positioning of the lock member, by use of the fastener 222 such as a cone point set screw driven into body 210 of the lock member 208. No advancement or retractment to a nearest locking position is needed. The user simply drives the set screw into the lock member at the exact position of the final bearing adjustment. The configuration of FIG. 8 is similar to the configurations of FIGS. 4A and 4B, except the oblong holes in the lock member are eliminated. For the configuration of FIG. 9A, recent advancements in projection welding and laser welding offer strong bonding and holding power of the lock member 208 to the outer race 218, to prevent outer race rotation/turning in the housing 224. Recent advancements in these welding techniques also prevent deleterious metallurgical alteration to the bearing outer race 218. FIG. 9B shows that the outer race 218 of FIG. 9A eliminates the need for radial slots in the front face of the outer race, as well as axial grooves in the threaded flange.

The present invention provides a lock member 226 (FIG. 9C) in the form of a fastener, such as a set screw. In this embodiment, an outer race 228 includes threads 230 on an outer diameter 232. The outer race 228 extends beyond its threads 230 to provide a cylindrical end surface 234. The outer diameter of the cylindrical end surface 234 is hard turned to remove the hard core and expose the soft core. A conical end 236 of fastener 226, when the fastener 226 is turned down, penetrates the outer cylindrical surface 232 to prevent the outer race 228 from rotation in housing 237. The outer race 228 may contain radial slots (not shown), which open out of its front face to engage a setting tool (not shown) to engage the outer race 228.

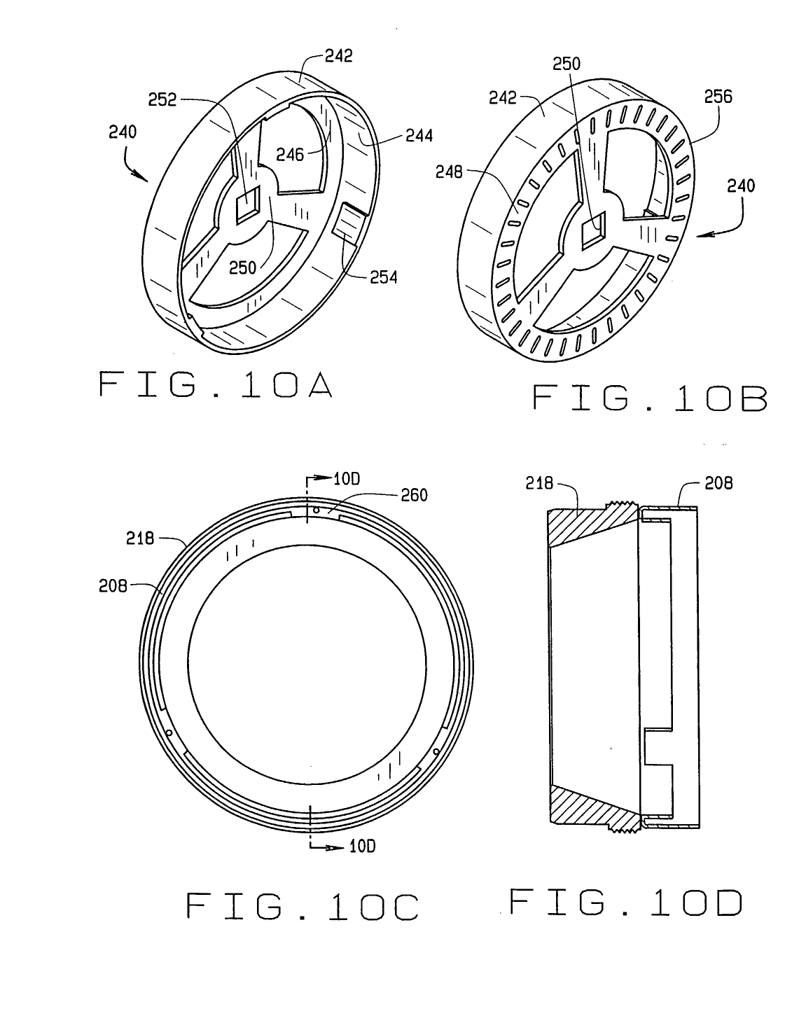

Turning to FIGS. 10A through 10F, the present invention provides a unique setting tool 240 that is configured to engage the lock members of the bearing assemblies. The unique setting tool 240 (FIGS. 10A and 10B) comprises an outer diameter 242 and an inner diameter 244, which includes a front face 246 and a back face 248.

The inner diameter 244 may also include a tool adaptor 250. The tool adaptor 250 may extend across inner diameter 244, wherein the tool adaptor 250 may define a tool aperture 252 there through. The tool aperture 252 provides access for a driver tool such as a socket drive to turn the setting tool 240. As such, the pattern of the tool adaptor 250 may be flexible for various advancement methods. The inner diameter 244 may also include at least one projection 254. In this embodiment, at least one projection 254 may extend from the inner diameter 244. The projections 254 of setting tool 240 engage the lock members. The back face 248 may include incremented markings 256, which aid in setting proper bearing adjustments.

The U-shaped lock member 208 (FIGS. 10C and 10D) of FIG. 9A is shown fastened to outer race 218 wherein the lock member 208 includes at least one slot 260. The slots 260 are positioned on the inner diameter of the lock member 208. The setting tool 240 engages with the lock member 208 (FIGS. 10E and 10F) such that at least one projection 254 inserts within at least one slot 260. As such, during operation, the engaged setting tool 240 drives the lock member 208/outer race 218 to a proper preload setting.

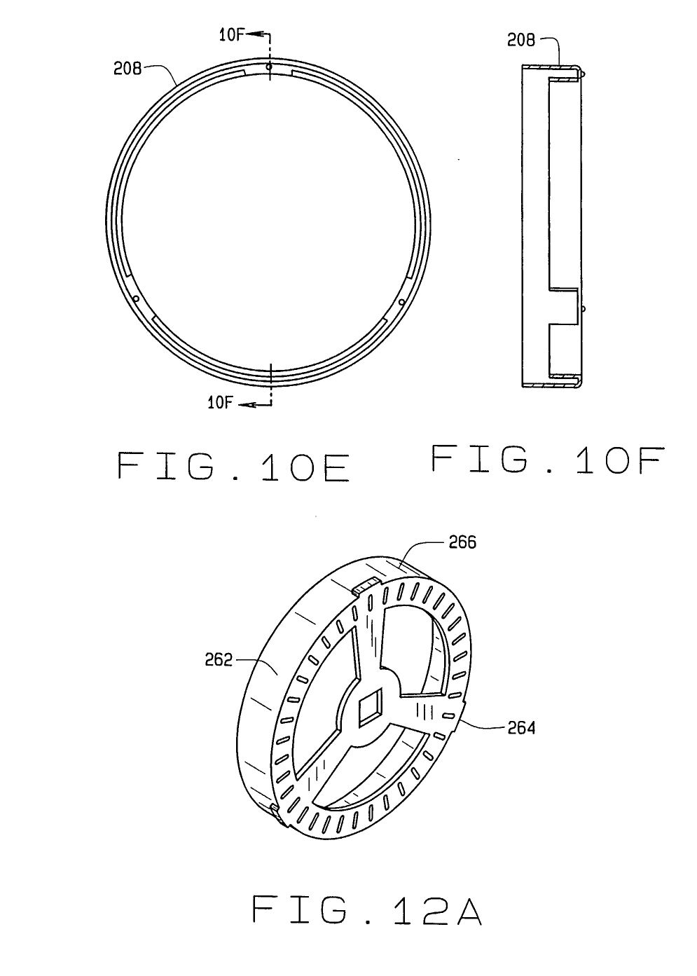

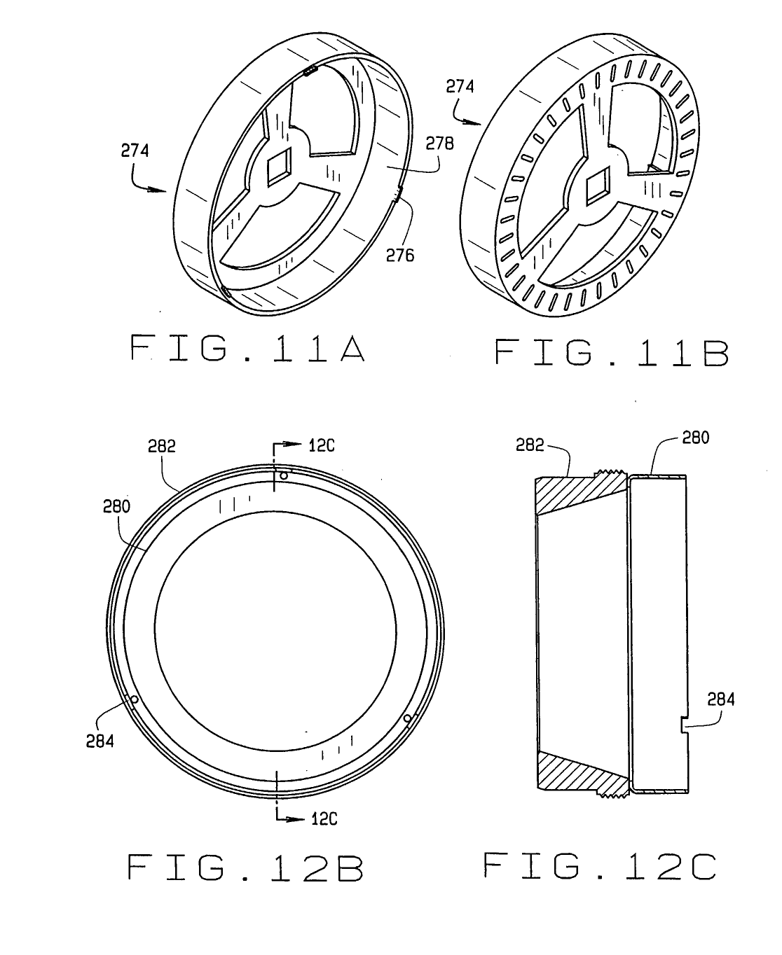

Another unique setting tool 274 (FIGS. 11A and 11B) incorporates components of setting tool 240 of FIGS. 10A and 10B. In this embodiment, however, at least one projection 276 may extend axially from an inner diameter 278 of setting tool 274.

An L-shaped lock member 268 (FIGS. 11C and 11D) is shown fastened to an outer race 270 wherein the lock member 268 includes at least one slot 272 configured to match at least one projection 276. The slots 272 are positioned on the inner diameter of the lock member 268. The setting tool 274 engages with the lock member 268 (FIGS. 11E and 11F) such that at least one projection 276 inserts within at least one slot 272. As such, during operation, the engaged setting tool 274 drives the lock member 268/outer race 270 to a proper preload setting.

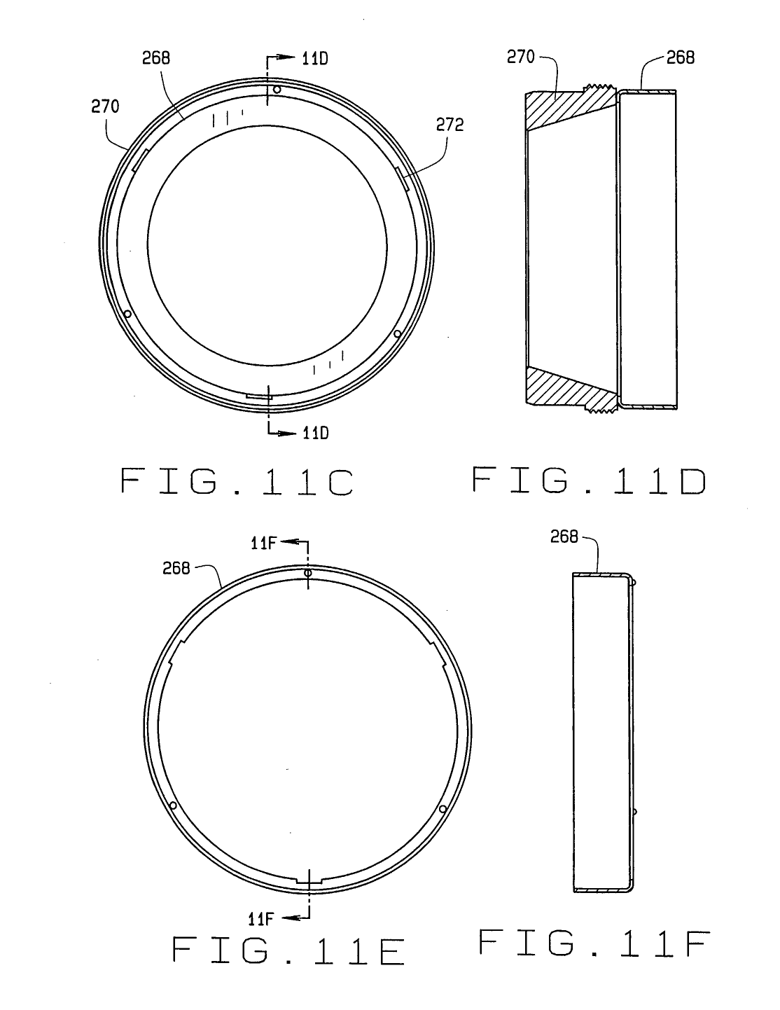

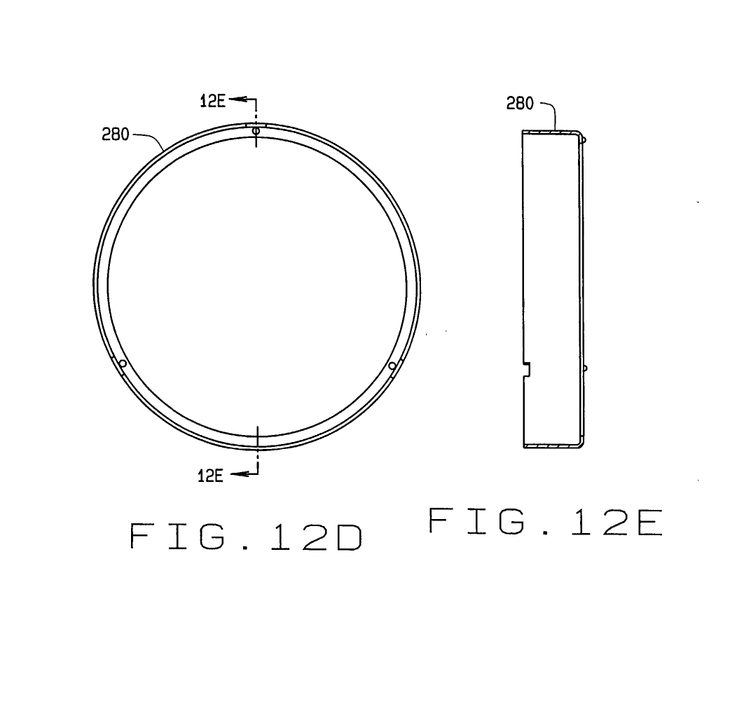

Yet another unique setting tool 262 (FIG. 12A) incorporates components of setting tools 240, 274. In this embodiment, however, at least one projection 264 may extend radially outward from an outer diameter 266 of setting tool 262.

An L-shaped lock member 280 (FIGS. 12B and 12C) is shown fastened to an outer race 282 wherein the lock member 280 includes at least one slot 284 configured to match at least one projection 264. The slots 284 are positioned in the edge of the outer diameter of the lock member 280. The setting tool 262 is engaged with the lock member 280 (FIGS. 12D and 12E) such that at least one projection 264 inserts within at least one slot 284. As such, during operation, the engaged setting tool 262 drives the lock member 280/outer race 282 to the proper preload setting.

The bearings described need not be tapered roller bearings, but may be any other antifriction bearings that can be adjusted against each other, such as angular contact ball bearings.

As various changes could be made in the above constructions without departing from the scope of the invention, it is intended that all matter contained in the above description or shown in the accompanying drawings shall be interpreted as illustrative and not in a limiting sense.

1-28. (canceled)

29. A bearing assembly for facilitating rotation about an axis, the bearing assembly comprising:
a housing having an internal thread presented toward the axis and also having a slot providing a well-defined surface that is oriented generally radially with respect to the axis;
an outer race received in the housing, the outer race having an external thread that engages the internal thread of the housing, so that rotation of the outer race in the housing will change the axial position of the outer race in the housing; and
a lock member attached to the outer race so that it cannot rotate with respect to the outer race, the lock member having a tab that projects into the slot and that lies along the well-defined surface, so that the lock member and outer race remain fixed against rotation in the housing.

30. A bearing assembly for facilitating rotation about an axis, the bearing assembly comprising:
a first member in the form of a housing, the housing having an internal thread presented toward the axis;
a second member in the form of an outer race, the outer race being received in the housing, the outer race having an external thread that engages the internal thread of the housing, so that rotation of the outer race in the housing will change the axial position of the outer race in the housing, the outer race having a raceway that is presented inwardly toward the axis and is inclined with respect to the axis;
one of the members providing a well-defined surface that is oriented generally radially with respect to the axis; and
a lock member attached to the other member so that lock member cannot rotate with respect to the other member, the lock member providing an edge that lies along the well-defined surface of the one member, so that the lock member and other member cannot rotate with respect to the one member.

31. The bearing assembly of claim 29 wherein the outer race has an axial groove and a radial slot such that the axial groove opens out of the outer race and the radial slot opens out of an end of the outer race, wherein the lock member couples to at least one of the axial groove and the radial slot of the outer race and couples to the housing, whereby the lock member prevents rotation of the outer race within the housing.

32. The bearing assembly of claim 31 wherein the lock member includes a body having a first end, a middle portion and a second end.

33. The bearing assembly of claim 31 wherein the first end includes an extension that engages the radial slot of the outer race and the second end includes a bendable ear that engages at least one radial slot of the housing.

34. The bearing assembly of claim 31 wherein the lock member includes a portion having a tube defining a plurality of holes there through, the lock member further including a fastener that inserts through a threaded hole of the housing and through one of the plurality of holes of the tube to fasten the lock member to the housing.

35. The bearing assembly of claim 32 wherein the body comprises a snap ring such that the first end comprises an outer diameter of the snap ring and the second end comprises an inner diameter of the snap ring.

36. The bearing assembly of claim 35 wherein the first end comprises a pair of extensions that engages at least one groove of the housing.

37. The bearing assembly of claim 36 wherein the second end includes at least one bendable ear that engages the radial slot of the outer race.

38. The bearing assembly of claim 32 wherein the first end includes at least one extension that extends into the axial groove of the outer race.

39. The bearing assembly of claim 32 wherein the middle portion comprises a tube having a dimple extending away from the tube and toward the housing such that the dimple engages the housing.

40. The bearing assembly of claim 32 wherein the secure end includes a lip that engages a keyway of the housing.

41. The bearing assembly of claim 32 further comprising a fastener that inserts through the housing and through the body.

42. In a vehicle differential including a housing having at least one bearing seat that is aligned along an axis, the housing includes a bore having an internal thread, a bearing assembly located in at least one bearing seat for supporting a pinion shaft, the bearing assembly, comprising:
a bearing located in at least one bearing seat and located around the pinion shaft, the bearing having
an outer race having a raceway that is inclined with respect to the axis, the outer race having an external thread on the narrow section end of the outer race, that is located around the outer race and that is engaged with the internal thread of the housing bore to set the bearing along the axis,
an inner race having a raceway located around the shaft, the raceway being inclined with respect to the axis in the same direction as the raceway for the outer race,
rolling elements located between and contacting the raceways; and
a lock member attached to the outer race and to the housing, the lock member including a body having a first end and a second end such that the first end attaches to the housing and the second end attaches to the outer race whereby the lock member prevents rotation of the outer race within the bearing seat of the housing.

43. In combination with the bearing assembly of claim 42, a setting tool comprising an inner diameter, an outer diameter and at least one projection which is configured to engage the lock member and turn the lock member when a torque is applied to the setting tool.

44. The bearing assembly of claim 42 further comprising a fastener that inserts through the housing and through the first end of the body to attach the first end to the housing and into the external thread of the outer race.

45. The bearing assembly of claim 42 wherein the housing includes a slot and the outer race includes another slot positioned through the external thread such that the first end of the lock member inserts through the slot in the housing while the second end of the lock member inserts through other slot in the outer race.

46. A process for securing a bearing assembly having a housing with a bearing seat that is concentric about an axis, the housing having a bore which has an internal thread and the housing having a slot, such that the bearing assembly located on the bearing seat supports a shaft, the process comprising:
inserting a bearing within the housing, the bearing comprising an outer race having a raceway that is inclined with respect to the axis, the outer race having an external thread on the narrow section end of the outer race, that is located around the outer race and that is engaged with the internal thread of the housing bore to set the bearing along the axis, the bearing further comprising an inner race having a raceway located around the shaft, the raceway being inclined with respect to the axis in the same direction as the raceway for the outer race and rolling elements located between and contacting the raceways;
rotating the outer race to engage the external thread and the internal thread until the bearing achieves a desired setting on the shaft; and
attaching a lock member to the outer race to prevent rotation of the outer race within the housing wherein the lock member has a tab that projects into the slot of the housing, whereby the lock member and outer race remain fixed against rotation in the housing.

47. The process according to claim 46 wherein attaching the outer race comprises engaging an extension of the lock member with a radial slot of the outer race.

48. The process according to claim 46 wherein attaching the outer race comprises engaging a bendable ear of the lock member with a slot of the housing.

49. The process according to claim 46 wherein attaching the outer race comprises engaging an extension of the lock member with an axial groove of the outer race.

50. The process according to claim 46 wherein attaching the outer race comprises fastening the lock member to the housing.

51. The process according to claim 50 wherein attaching the outer race comprises fastening the lock member to the outer race.
